(19) United States
(12) Patent Application Publication
(10) Pub. No.: US 2025/0144885 A1
(43) Pub. Date: May 8, 2025

(54) IMAGE GENERATION CONTROL DEVICE AND OPTICAL SHAPING DEVICE

(71) Applicant: JVCKENWOOD Corporation, Yokohama-shi (JP)

(72) Inventor: Hiroyuki Takada, Yokohama-shi (JP)

(21) Appl. No.: 19/017,828

(22) Filed: Jan. 13, 2025

Related U.S. Application Data
(63) Continuation of application No. PCT/JP2023/018704, filed on May 19, 2023.

(30) Foreign Application Priority Data
Aug. 26, 2022 (JP) 2022-135100

(51) Int. Cl. B29C 64/386; B29C 64/129; B29C 64/255; B29C 64/264; B33Y 30/00; B33Y 50/00

(52) U.S. Cl. CPC B29C 64/386; B29C 64/129; B29C 64/255; B29C 64/264; B33Y 30/00; B33Y 50/00

(57) ABSTRACT

Provided are an image generation control device and an optical shaping device capable of accurately forming a shaped object while enhancing adhesion between cured layers. An image generation control device includes: a data holding unit that holds data on a cross-sectional shape corresponding to each cured layer of a shaped object; an analysis unit that analyzes the number of layers including a photocurable resin layer irradiated with light and cured layers consecutively laminated in a thickness direction of the photocurable resin layer for each region obtained by dividing a cross-sectional shape of the photocurable resin layer; and an image signal generation unit that generates an image signal of light having luminance different for each region according to the analyzed number of layers.

### CROSS-REFERENCE TO RELATED APPLICATIONS

This application is a Continuation of PCT International Application No. PCT/JP2023/018704 filed on May 19, 2023 which claims the benefit of priority from Japanese Patent Application No. 2022-135100 filed on Aug. 26, 2022, the entire contents of both of which are incorporated herein by reference.

### BACKGROUND OF THE INVENTION

### 1. Field of the Invention

The present disclosure relates to an image generation control device and an optical shaping device.

### 2. Description of the Related Art

In general, an optical shaping technique is known in which a liquid photocurable resin is irradiated with light such as ultraviolet light to form a three-dimensional shaped object made of a cured resin. JP 2020-62841 A discloses an optical shaping technique for forming a desired shaped object by laminating cured layers by repeating a step of irradiating a base disposed opposite to a light transmission window provided on a bottom surface of a liquid tank storing a photocurable resin with light corresponding to a cross-sectional shape at a predetermined height position of the shaped object through the light transmission window toward the base, and shaping a cured layer in which the resin is cured in the same shape as the predetermined cross section on a lower surface of the base, and a step of pulling up the base by a predetermined height with respect to the liquid tank.

By the way, in this type of optical shaping technique in which cured layers are laminated one by one, it is preferable to enhance adhesion between cured layers by irradiating the cured layers with light having luminance reaching the boundary between the cured layers even after sequentially forming the cured layers. However, in the cross-sectional shape of the photocurable resin (resin layer) actually irradiated with light, the thickness of the cured layers laminated on the resin layer varies for each region, making it difficult to set appropriate luminance, and there is room for improvement in terms of accurately forming a shaped object.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

An image generation control device that controls light with which a surface of a photocurable resin is to be irradiated to sequentially form cured layers of a shaped object, the image generation control device according to the present disclosure comprising: a data holding unit that holds data on a cross-sectional shape corresponding to each of the cured layers of the shaped object; an analysis unit that analyzes the number of layers including a resin layer of the photocurable resin irradiated with the light and cured layers consecutively laminated in a thickness direction of the resin layer for each region obtained by dividing the cross-sectional shape; and an image signal generation unit that generates an image signal of light having luminance different for the each region according to the analyzed number of layers.

An optical shaping device according to the present disclosure comprising: a shaping tank that stores a photocurable resin, the shaping tank having a light transmissive portion on a bottom surface thereof; a light irradiation unit that irradiates light for curing the photocurable resin through the light transmissive portion; a platform that is movable up and down with respect to the shaping tank while facing the light transmissive portion; and an image generation control device that controls the light to be irradiated by the light irradiation unit to sequentially form cured layers of a shaped object, wherein the image generation control device includes: a data holding unit that holds data on a cross-sectional shape corresponding to each of the cured layers of the shaped object; an analysis unit that analyzes the number of layers including a resin layer of the photocurable resin irradiated with the light and cured layers consecutively laminated in a thickness direction of the resin layer for each region obtained by dividing the cross-sectional shape; and an image signal generation unit that generates an image signal of light having luminance different for the each region according to the analyzed number of layers.

### BRIEF DESCRIPTION OF THE DRAWINGS

FIG. 1 is a schematic diagram illustrating a basic configuration of an optical shaping device according to the present embodiment;

FIG. 2 is a schematic view illustrating a relationship between the number of layers including a photocurable resin layer and cured layers laminated on the photocurable resin layer and a region of the photocurable resin layer; and

FIG. 3 is a flowchart illustrating a procedure of an operation of the image generation control device.

### DETAILED DESCRIPTION OF THE PREFERRED EMBODIMENTS

Hereinafter, the present embodiment will be described in detail with reference to the accompanying drawings. Note that the present disclosure is not limited by the present embodiment, and in a case where there are multiple embodiments, the present disclosure also includes configurations in which the embodiments are combined. In addition, in the following embodiment, the same parts are denoted by the same reference numerals, and redundant description will be omitted.

In the following description of embodiments, unless otherwise specified, a non-cured (uncured) liquid photocurable resin will be simply referred to as a photocurable resin. In addition, a photocurable resin layer having a predetermined thickness to be described later, which is provided between a platform or a shaped object held on the platform and a light transmissive plate and cured by light irradiation, will be referred to as a photocurable resin layer or will be simply referred to as a resin layer. Further, a photo-shaped object formed by curing a liquid photocurable resin will be referred to as a three-dimensional shaped object or will be simply referred to as a shaped object. This three-dimensional shaped object is not limited to a finished product in which all of a plurality of cured layers that need to be formed have been laminated, and includes an unfinished product in a stage where cured layers are being laminated in the middle.

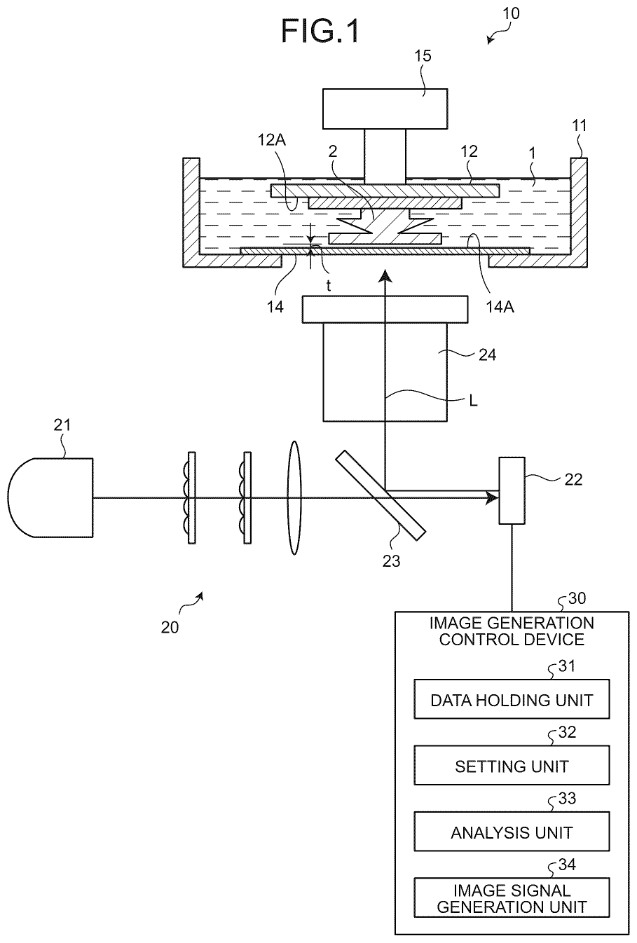

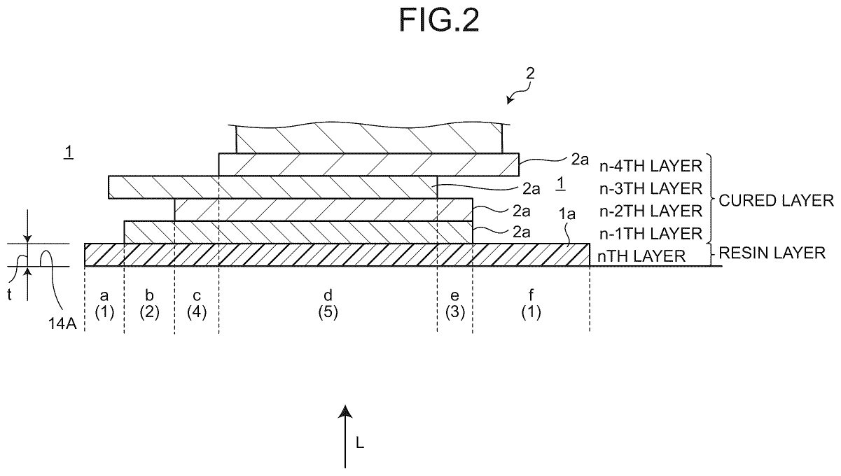

FIG. 1 is a schematic diagram illustrating a basic configuration of an optical shaping device according to the present embodiment. FIG. 2 is a schematic view illustrating a relationship between the number of layers including a photocurable resin layer and cured layers laminated on the photocurable resin layer and a region of the photocurable resin layer. As illustrated in FIG. 1, an optical shaping device 10 includes a shaping tank 11, a platform 12, a light irradiation unit 20, and an image generation control device 30.

The shaping tank 11 has a shape like a dish that is open on the upper side, and can store a liquid photocurable resin 1. The shaping tank 11 has a light transmissive plate (light transmissive portion) 14 on the bottom surface. The light transmissive plate 14 transmits light for curing the photocurable resin 1.

The photocurable resin 1 is a raw material of a three-dimensional shaped object 2, and contains, for example, a polymerizable compound such as an acrylic compound or a vinyl compound. The photocurable resin 1 preferably contains a polymerization initiator that generates radical species and the like by light irradiation.

The platform 12 holds the shaped object 2 made of the cured photocurable resin 1, and is disposed in an upper portion of the shaping tank 11 to face the light transmissive plate 14. The platform 12 is formed in, for example, a circular plate shape or a polygonal plate shape such as a rectangular plate shape, and is disposed such that a lower surface 12A thereof is substantially parallel to an upper surface 14A of the light transmissive plate 14. The platform 12 is connected to the platform lifting mechanism 15, and is provided so as to be movable up and down with respect to the shaping tank 11 by operating the platform lifting mechanism 15. Specifically, the platform 12 can approach or retract with respect to the light transmissive plate 14, and holds the shaped object 2 formed on the lower surface 12A facing the light transmissive plate 14.

The light irradiation unit 20 is disposed, for example, below the shaping tank 11, that is, on the side opposite to the platform 12 with the light transmissive plate 14 interposed therebetween. The light irradiation unit 20 irradiates the photocurable resin 1 with light L that corresponds to, for example, a predetermined cross-sectional shape of a target shaped object and cures the photocurable resin 1 through the light transmissive plate 14. The light L to be irradiated may be any light capable of curing the photocurable resin 1, and for example, ultraviolet light or visible light having a short wavelength is used. The light irradiation unit 20 includes a light source 21 such as an ultraviolet lamp, an image forming element 22, a reflection mirror 23, and a projection lens 24.

The light source 21 emits light to irradiate the image forming element 22, and for example, an ultraviolet lamp or the like is used. The image forming element 22 modulates light according to data on a cross-sectional shape of each layer of the shaped object 2 to be formed, and for example, a liquid crystal on silicon (LCOS) device, a digital mirror device (DMD), or a liquid crystal device can be used. Furthermore, in the present embodiment, the image forming element 22 can modulate light having luminance different for each predetermined region (for example, each pixel of the image forming element 22) in the above-described cross-sectional shape under the control of the image generation control device 30. Here, the luminance of light is a value indicating to what thickness the photocurable resin 1 to be irradiated can be transmitted, that is, cured. Therefore, the higher the luminance of light, the higher the light energy to be irradiated, so that the light can be transmitted through a thicker photocurable resin 1 to cure the photocurable resin 1.

The reflection mirror 23 reflects the light modulated by the image forming element 22 toward the projection lens 24. The projection lens 24 forms an image of the light reflected by reflection mirror 23. Note that the light irradiation unit 20 is not limited thereto, and for example, a laser scanning device using driving of a laser light source and a mirror or an optical device using a reflection optical system or a refraction optical system may be used.

In the present embodiment, as illustrated in FIG. 1, the optical shaping device 10 forms a photocurable resin layer having a predetermined thickness t between the platform 12 or the shaped object 2 and the light transmissive plate 14, and irradiates the photocurable resin layer with light modulated by the image forming element 22 to have a predetermined cross-sectional shape. As a result, a cured layer in which the resin is cured in the same shape as the predetermined cross section is formed on the platform 12 or the shaped object 2. The predetermined thickness t is set to a thickness (e.g., about several um to 100 μm) for one cured layer to be formed. After the irradiation, the platform 12 is pulled up by the same distance as the predetermined thickness t, and a photocurable resin layer having the predetermined thickness t is further formed between the platform 12 or the shaped object 2 and the light transmissive plate 14. In this manner, the optical shaping device 10 repeatedly executes a step of irradiating a photocurable resin layer having the predetermined thickness t with light and a step of pulling up the platform 12 by the predetermined thickness t, thereby laminating cured layers to form a shaped object 2 having a target shape.

The image generation control device 30 is, for example, an arithmetic processing device including a central processing unit (CPU) and the like, and controls the operation of the light irradiation unit 20. The image generation control device 30 stores a program related to an operation of irradiating the photocurable resin 1 with light, loads the program into a memory, and executes a command included in the program. The image generation control device 30 includes an internal memory (not illustrated), and the internal memory is used for temporary storage of data such as a program in the image generation control device 30.

For example, the image generation control device 30 calculates a light irradiation pattern indicating a cross-sectional shape of a shaped object at a predetermined height interval based on the three-dimensional shape data, and controls the image forming element 22 and the like to irradiate the photocurable resin 1 with light. The image generation control device 30 includes a data holding unit 31, a setting unit 32, an analysis unit 33, and an image signal generation unit 34.

The data holding unit 31 holds data on a cross-sectional shape corresponding to each layer (each cured layer) when the target shaped object 2 is formed. That is, in a case where the target shaped object 2 is formed of k layers (k is a natural number), the data holding unit 31 holds data on cross-sectional shapes of all the layers from the first layer to the kth layer.

When the surface of the photocurable resin 1 is irradiated with light, the setting unit 32 sets a maximum number of layers that the light reaches. That is, the setting unit 32 sets a maximum number of layers to be irradiated with light energy to be cured. As illustrated in FIG. 2, the shaped object 2 is configured by laminating a plurality of cured layers 2a each having a predetermined cross-sectional shape, and a photocurable resin layer 1a having a predetermined thickness t is formed between the upper surface 14A of the light transmissive plate 14 and a latest cured layer 2a. At this time, the photocurable resin 1 is present around the cured layer 2a.

In the present embodiment, the maximum number of layers is set to a total of five layers including a photocurable resin layer 1a (nth layer) to be cured and four cured layers 2a (an n−1th layer to an n−4th layer) consecutively laminated on the photocurable resin layer 1a, but it may be any number as long as the layers at least include one photocurable resin layer 1a (nth layer) and two or more cured layers 2a. The setting unit 32 can set the maximum number of layers to be changeable in advance by a method such as a user input. According to the present embodiment, when the surface of the photocurable resin 1 is irradiated with light L, the light is transmitted through the photocurable resin layer 1a and the cured layers 2a to a thickness (t×5) corresponding to the set maximum number of layers (five layers). Therefore, the photocurable resin layer 1a can be cured, and the uncured photocurable resin 1 remaining, for example, between the cured layers 2a can also be cured, so that adhesion between the cured layers 2a can be enhanced.

The analysis unit 33 analyzes the number of layers obtained by adding the photocurable resin layer 1a irradiated with the light L and the cured layers 2a consecutively laminated in the thickness direction of the photocurable resin layer 1a within the range of the set maximum number of layers, for each predetermined region obtained by dividing the cross-sectional shape of the photocurable resin layer 1a. Specifically, the analysis unit 33 reads image data on the cross-sectional shapes of the nth to n−4th layers from the data holding unit 31, and analyzes the number of layers including the photocurable resin layer 1a and the cured layers 2a for each predetermined region of the photocurable resin layer 1a. In the example of FIG. 2, in the range of the set maximum number of layers of 5 or less, the analysis unit 33 analyzes the number of layers in region a obtained by dividing the cross-sectional shape of the photocurable resin layer 1a as 1. Similarly, the analysis unit 33 analyzes that the number of layers in region b is 2, the number of layers in region c is 4, the number of layers in region d is 5, the number of layers in region e is 3, and the number of layers in region f is 1. In addition, the analysis unit 33 preferably analyzes the number of layers described above for each pixel unit (for each pixel) of the image forming element 22 that modulates light (image light) L with which the photocurable resin layer 1a is irradiated as the predetermined region.

The image signal generation unit 34 generates an image signal of light having luminance different according to the analyzed number of layers for each region (pixel). That is, the image signal generation unit 34 generates an image signal having a luminance signal different according to the number of layers consecutively laminated for each region (pixel). For example, when the luminance (light energy) for curing the photocurable resin layer 1a for k layers (k is a natural number) is defined as Pk, the image signal generation unit 34 has luminance P1 in regions a and f (one layer). Further, P1<luminance in region b<P2 in region b (two layers), and P2<luminance in region e<P3 in region e (three layers). In addition, P3<luminance in region c<P4 in region c (four layers), and P4<luminance in region d<P5 in region d (five layers). Here, by setting the luminance (light energy) corresponding to the number of layers to a numerical value equal to or less than the number of laminated layers, the image signal generation unit 34 prevents light from being transmitted through the uppermost one of the consecutively laminated cured layers 2a and curing the photocurable resin 1 in contact with the upper surface of the uppermost cured layer 2a.

Usually, when the photocurable resin layer 1a is laminated and cured, if light L having luminance (light energy) necessary for curing only the photocurable resin layer 1a is irradiated, the photocurable resin layer 1a is cured to form a cured layer 2a, but adhesion between the cured layers 2a is low, and peeling easily occurs at a boundary. On the other hand, if the luminance (light energy) is increased to enhance the adhesion, for example, a thickness of a partially protruding portion of the cured layer 2a, such as an overhang portion, will increase, which results in a problem that it is not possible to form a shaped object 2 with high accuracy.

In the present embodiment, as described above, the number of layers, including the photocurable resin layer 1a and the cured layers 2a consecutively laminated, is analyzed for each predetermined region obtained by dividing the cross-sectional shape of the photocurable resin layer 1a, and the photocurable resin layer 1a is irradiated with image light having luminance different according to the analyzed number of layers for each region (pixel). This makes it possible to cure the photocurable resin layer 1a in the predetermined cross-sectional shape, and irradiate the boundary between the cured layer 2a with light multiple times. Therefore, the uncured photocurable resin 1 remaining at the boundary between the cured layers 2a can be cured, thereby increasing the adhesion between the cured layers 2a. Furthermore, in the present embodiment, since the predetermined region is set for each pixel unit (for each pixel) of the image forming element 22, the target shaped object 2 can be accurately molded.

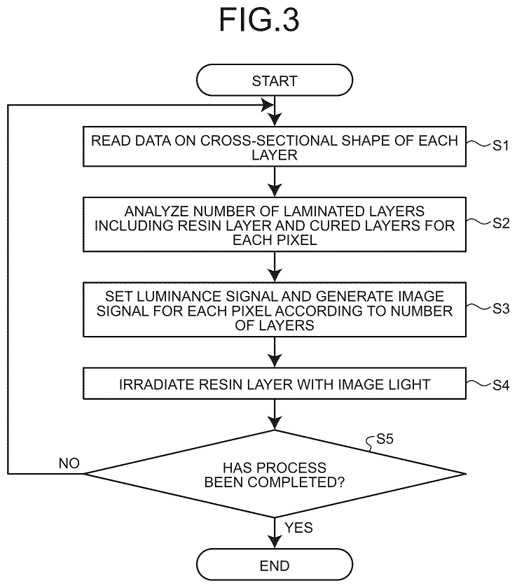

Next, a procedure of the operation of the image generation control device 30 according to the present embodiment will be described. FIG. 3 is a flowchart illustrating the procedure of the operation of the image generation control device. In this operation procedure, it is assumed that, when forming the target shaped object 2, the maximum number of layers (five layers) that the light irradiated onto the photocurable resin layer 1a reaches is set in advance. First, the image generation control device 30 reads data on the cross-sectional shape corresponding to each layer of the target shaped object 2 from the data holding unit 31 (step S1). Specifically, the image generation control device 30 reads, from the data holding unit 31, data on cross-sectional shapes corresponding to the photocurable resin layer 1a (nth layer) to be irradiated and the four cured layers 2a (n−1th to 4-4th layers) consecutively laminated on the photocurable resin layer 1a.

Subsequently, the image generation control device 30 analyzes the number of laminated layers including the photocurable resin layer 1a and the cured layers 2a for each pixel using the analysis unit 33 (step S2). The analysis unit 33 analyzes the number of layers obtained by adding the photocurable resin layer 1a irradiated with the light L and the cured layers 2a consecutively laminated in the thickness direction of the photocurable resin layer 1a within the range of the above-described maximum number of layers (five layers), for each pixel obtained by dividing the cross-sectional shape of the photocurable resin layer 1a.

Subsequently, the image generation control device 30 sets a luminance signal and generates an image signal for each pixel according to the analyzed number of layers (step S3). The image signal generation unit 34 generates an image signal having a luminance signal different according to the number of layers consecutively laminated for each pixel.

Subsequently, the image generation control device 30 irradiates the photocurable resin layer 1a with light (image light) (step S4). The image generation control device 30 controls the image forming element 22 on the basis of the generated image signal to irradiate the photocurable resin layer 1a with light (image light) corresponding to the cross-sectional shape of the photocurable resin layer 1a and having luminance different according to the number of layers consecutively laminated for each pixel. As a result, the photocurable resin layer 1a can be cured in the same shape as the cross-sectional shape to form a cured layer (nth layer), and the uncured photocurable resin 1 remaining at the boundary between the cured layers 2a can be cured to improve adhesion between the cured layers 2a.

Subsequently, the image generation control device 30 determines whether the process has been completed (step S5). Specifically, the image generation control device 30 determines whether there is still a layer to be formed by determining whether the process has been completed. When the process has not been completed (there is still a layer to be formed) (step S5; No), the image generation control device 30 returns the process to step S1. In addition, the process has been completed (there is no more layer to be formed) (step S5; In the case of Yes), the image generation control device 30 ends the process.

As described above, the optical shaping device 10 according to the present embodiment includes: a shaping tank 11 that stores a photocurable resin 1, the shaping tank 11 being provided with a light transmissive plate 14 on a bottom surface thereof; a light irradiation unit 20 that irradiates light L for curing the photocurable resin 1 through the light transmissive plate 14; a platform 12 that is movable up and down with respect to the shaping tank 11 while facing the light transmissive plate 14; and an image generation control device 30 that controls the light L to be irradiated by the light irradiation unit 20 to sequentially form each cured layer 2a of a shaped object 2, the image generation control device 30 including: a data holding unit 31 that holds data on a cross-sectional shape corresponding to each cured layer 2a of the shaped object 2; an analysis unit 33 that analyzes the number of layers including a photocurable resin layer 1a irradiated with the light L and cured layers 2a consecutively laminated in a thickness direction of the photocurable resin layer 1a for each region obtained by dividing a cross-sectional shape of the photocurable resin layer 1a; and an image signal generation unit 34 that generates an image signal of light having luminance different for each region according to the analyzed number of layers.

According to this configuration, the image generation control device 30 controls the light irradiation unit 20 on the basis of the generated image signal to irradiate the photocurable resin layer 1a with light L (image light) corresponding to the cross-sectional shape of the photocurable resin layer 1a and having luminance different according to the number of layers consecutively laminated for each region. As a result, the photocurable resin layer 1a can be cured in the same shape as the cross-sectional shape to form a cured layer 2a, and the uncured photocurable resin 1 remaining at the boundary between the cured layers 2a can be cured. Therefore, the shaped object 2 can be accurately molded while enhancing adhesion between the cured layers 2a.

Furthermore, in the optical shaping device 10 according to the present embodiment, the image generation control device 30 includes a setting unit 32 that sets a maximum number of layers that the light L with which a surface of the photocurable resin 1 is irradiated reaches to cure an uncured photocurable resin remaining between the cured layers 2a, and the analysis unit 33 analyzes the number of layers for each region within a range of the maximum number of layers. According to this configuration, the boundary between the cured layers 2a can be irradiated with light multiple times, and the uncured photocurable resin 1 remaining at the boundary between the cured layers 2a can be cured. Furthermore, by setting the maximum number of layers, excessive irradiation of light can be suppressed, making it possible to easily from the shaped object 2.

Furthermore, in the optical shaping device 10 according to the present embodiment, since the region is set on a pixel basis, the shaped object 2 can be formed more accurately.

Although the image generation control device 30 according to the present embodiment and the optical shaping device 10 including the same have been described so far, the image generation control device and the optical shaping device may be implemented in various different forms other than the above-described embodiment. Furthermore, each component of the illustrated optical shaping device is functionally conceptual, and does not need to be physically configured as illustrated. That is, the specific form of each device is not limited to the illustrated form, and all or some of the device may be functionally or physically distributed or integrated in any unit depending on the processing load, the usage situation, or the like of each device.

The configuration of the image generation control device 30 is realized, for example, as software, by a program loaded into the memory. In the above-described embodiment, the functional blocks are described as being realized by cooperation of hardware or software. That is, these functional blocks can be realized in various forms by hardware alone, software alone, or a combination of hardware and software.

According to the present embodiment, it is possible to accurately form a shaped object while enhancing adhesion between cured layers.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image generation control device that controls light with which a surface of a photocurable resin is to be irradiated to sequentially form cured layers of a shaped object, the image generation control device comprising:
a data holding unit that holds data on a cross-sectional shape corresponding to each of the cured layers of the shaped object;
an analysis unit that analyzes the number of layers including a resin layer of the photocurable resin irradiated with the light and cured layers consecutively laminated in a thickness direction of the resin layer for each region obtained by dividing the cross-sectional shape;
an image signal generation unit that generates an image signal of light having luminance different for the each region according to the analyzed number of layers; and
a setting unit that sets a maximum number of layers that the light with which the surface of the photocurable resin is irradiated reaches to cure an uncured photocurable resin remaining between the cured layers,
wherein the analysis unit analyzes the number of layers for the each region within a range of the maximum number of layers.

2. The image generation control device according to claim 1, wherein the region is set on a pixel basis.

3. An optical shaping device comprising:
a shaping tank that stores a photocurable resin, the shaping tank having a light transmissive portion on a bottom surface thereof;
a light irradiation unit that irradiates light for curing the photocurable resin through the light transmissive portion;
a platform that is movable up and down with respect to the shaping tank while facing the light transmissive portion; and
an image generation control device that controls the light to be irradiated by the light irradiation unit to sequentially form cured layers of a shaped object,
wherein the image generation control device includes:
a data holding unit that holds data on a cross-sectional shape corresponding to each of the cured layers of the shaped object;
an analysis unit that analyzes the number of layers including a resin layer of the photocurable resin irradiated with the light and cured layers consecutively laminated in a thickness direction of the resin layer for each region obtained by dividing the cross-sectional shape;
an image signal generation unit that generates an image signal of light having luminance different for the each region according to the analyzed number of layers; and
a setting unit that sets a maximum number of layers that the light with which the surface of the photocurable resin is irradiated reaches to cure an uncured photocurable resin remaining between the cured layers,
wherein the analysis unit analyzes the number of layers for the each region within a range of the maximum number of layers.
